(19) United States
(12) Patent Application Publication
(10) Pub. No.: US 2021/0331404 A1
(43) Pub. Date: Oct. 28, 2021

(54) SUPPLY BUILD MATERIALS BASED ON THEORETICAL HEATMAPS

(71) Applicant: HEWLETT-PACKARD DEVELOPMENT COMPANY, L.P., Spring, TX (US)

(72) Inventors: Mohammad Jowkar, Sant Cugat del Valles (ES); Yngvar Sethne Rossnow, Sant Cugat del Valles (ES); Adrien Chiron, Sant Cugat del Valles (ES)

(21) Appl. No.: 16/605,596

(22) PCT Filed: May 25, 2018
(86) PCT No.: PCT/US2018/034602

§ 371 Date: Oct. 16, 2019

(51) Int. Cl. B29C 64/393; B29C 64/232; B29C 64/245; B29C 64/214; B29C 64/321; B29C 64/295; B33Y 40/00; B33Y 50/02

(52) U.S. Cl. CPC B29C 64/393; B29C 64/232; B29C 64/245; B29C 64/214; B33Y 10/00; B29C 64/295; B33Y 40/00; B33Y 50/02; B29C 64/321

(57) ABSTRACT

An example of an additive manufacturing system is disclosed. The example disclosed herein comprises a controller. The controller is to generate a theoretical heatmap representing portions of a layer of build material heated during processing of a previously formed layer supplied to a build bed. The controller is also to calculate, based on the theoretical heatmap, an amount of build material needed in a next layer to be supplied to the build bed. The controller is further to instruct a supply module to supply the amount of build material to the build bed.

### BACKGROUND

Additive manufacturing may comprise the operation of spreading additive manufacturing build material in a build bed and printing or jetting an energy absorbing fusing agent over areas of successive layers of un-solidified build material to be fused, and applying a fusing energy to the build bed to cause portions thereof on which fusing agent was printed to heat up, melt, coalesce, sinter, or fuse.

In some circumstances, the operation of spreading the additive manufacturing build material may not result in a flat layer of material.

### BRIEF DESCRIPTION OF THE DRAWINGS

The present application may be more fully appreciated in connection with the following detailed description taken in conjunction with the accompanying drawings, in which like reference characters refer to like parts throughout and in which:

FIG. 1 is a block diagram illustrating an example of an additive manufacturing system to supply build materials based on theoretical heatmaps.

FIG. 2 is a schematic diagram illustrating an example of an additive manufacturing system to supply build materials based on theoretical heatmaps.

FIG. 3 is a schematic diagram illustrating another example of an additive manufacturing system to supply build materials based on theoretical heatmaps.

FIG. 4A is a schematic diagram illustrating an example of a previously fused build material layer.

FIG. 4B is a schematic diagram illustrating an example of a theoretical heatmap.

FIG. 4C is a schematic diagram illustrating an example of a plurality of previously fused build material layers.

FIG. 5 is a block diagram illustrating another example of an additive manufacturing system to supply build materials based on theoretical heatmaps.

FIG. 6A is a schematic diagram illustrating an example of a supply module.

FIG. 6B is a schematic diagram illustrating another example of a supply module.

FIG. 7 is a flowchart of an example method for supplying build materials based on a theoretical heatmap.

FIG. 8 is a flowchart of another example method for supplying build materials based on a theoretical heatmap.

FIG. 9 is a block diagram illustrating an example of a processor-based system to supply build materials based on a theoretical heatmap.

### DETAILED DESCRIPTION

The following description is directed to various examples of the disclosure. In the foregoing description, numerous details are set forth to provide an understanding of the examples disclosed herein. However, it will be understood by those skilled in the art that the examples may be practiced without these details. While a limited number of examples have been disclosed, those skilled in the art will appreciate numerous modifications and variations therefrom. It is intended that the appended claims cover such modifications and variations as fall within the scope of the examples. Throughout the present disclosure, the terms “a” and “an” are intended to denote at least one of a particular element. In addition, as used herein, the term “includes” means includes but not limited to, the term “including” means including but not limited to. The term “based on” means based at least in part on.

In additive manufacturing, a three-dimensional (3D) object to be generated (e.g., an object model) may be divided in a plurality of slices. Each slice defines portions of corresponding layers of build material which are to be solidified to generate the 3D object. The generation of each layer of the 3D object may comprise the operations of (i) supplying additive manufacturing build material (referred hereinafter as build material) to a build bed, (ii) spreading the build material on the build bed, (iii) printing or jetting an energy absorbing fusing agent over areas of successive layers of un-solidified build material, and (iv) apply energy to the build bed to fuse the build material on which fusing agent has been printed. According to one example, a suitable build material may be PA12 build material commercially known as V1R10A “HP PA12” available from HP Inc. Each layer may then be exposed to fusing energy to selectively melt layers of a part of a three-dimensional object that is to be generated. According to another example, a suitable fusing agent may be an ink-type formulation comprising carbon black, such as, for example, the fusing agent formulation commercially known as V1Q60Q “HP fusing agent” available from HP Inc. In one example such a fusing agent may additionally comprise an infra-red light absorber. In one example such an ink may additionally comprise a near infra-red light absorber. In one example such a fusing agent may additionally comprise a visible light absorber. In one example such an ink may additionally comprise a UV light absorber. Examples of inks comprising visible light enhancers are dye based colored ink and pigment based colored ink, such as inks commercially known as CE039A and CE042A available from HP Inc.

The operation of spreading the additive manufacturing build material may, in some circumstances, not result in a uniform layer of material that is within the boundaries of the build bed. The term “underflow” is intended to describe when an insufficient quantity of build material is provided to the build bed, resulting in an incomplete layer of build material being formed. Underflow may cause unexpected finishing of the object printed, for example, sinks, degraded material properties, thermal bleeding, and the like. Similarly, supplying with an excess of build material may result in that said build material (i.e., “overflow”) may accumulate and block movements of other elements (e.g., printheads, recorders), and/or airborne. Supplying the appropriate amount of build material to the building bed may reduce the effects of overflow and underflow.

The operation of determining an amount of build material to be spread over the build bed may be challenging. In an example, to form each layer of build material layer, a sufficient quantity of build material should be supplied to the build bed so that, when spread, the build material forms a layer of build material having a flat top surface. However, the quantity of build material may vary on a layer-by-layer basis, based on what was fused in the previous layer due to contraction of the fused portions. In another example, contraction may be caused due to densification of the build material due to the build material powder particles fusing together.

One example of the present disclosure provides an additive manufacturing system that comprises a controller. The controller is to (i) generate a theoretical heatmap representing portions of a layer of build material heated during the processing of a previously formed layer supplied to the build bed. The heatmap may be an estimation of the thermal characteristics of the build bed. The controller is also to (ii) calculate, based on said theoretical heatmap, an amount of build material needed in a next layer to be supplied to the build bed. The controller is further to (iii) instruct the supply module to supply the amount of build material to the build bed. The controller is also to (iv) instruct a recoating mechanism to spread the amount of build material on the build bed to form a layer.

Another example of the present disclosure provides a method comprising a plurality of operations to be performed. The method comprises (i) receiving data representing a slice of a model of an object to be generated from a layer of build material. The method also comprises (ii) generating a theoretical heatmap representing portions of a layer of build material heated during processing of a previously formed layer supplied to a build bed. The heatmap may be an estimation of the thermal characteristics of the build bed. The method further comprises (iii) calculating, based on the theoretical heatmap, an amount of build material needed in a next layer to be supplied to the build bed. The method also comprises (iv) instructing a supply module to supply the amount of build material to the build bed. The method further comprises (v) ejecting fusing agent to the build bed based on the data representing the slice of the model. And the method comprises (vi) apply energy to the build bed.

Another example of the present disclosure provides a non-transitory machine readable medium storing instructions executable by a processor. The non-transitory machine-readable medium comprises (i) instructions to receive data representing a slice of a model of an object to be generated from a layer of build material. The non-transitory machine-readable medium also comprises (ii) instructions to generate a theoretical heatmap representing portions of a layer of build material heated during processing of a previously formed layer supplied to the build bed. The theoretical heatmap may be an estimation of the thermal characteristics of the build bed. The non-transitory machine-readable medium further comprises (iii) instructions to calculate, based on the theoretical heatmap, an amount of build material needed in a next layer to be supplied to the build bed. The non-transitory machine-readable medium also comprises (iv) instructions to instruct the supply module to supply the amount of build material to the build bed. The non-transitory machine-readable medium further comprises (v) instructions to eject fusing agent to the build bed based on the data representing the slice of the model. And the non-transitory machine-readable medium also comprises (vi) instructions to apply energy to the build bed.

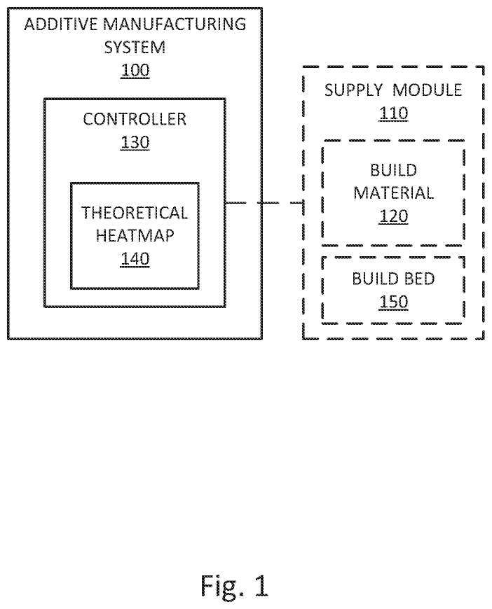

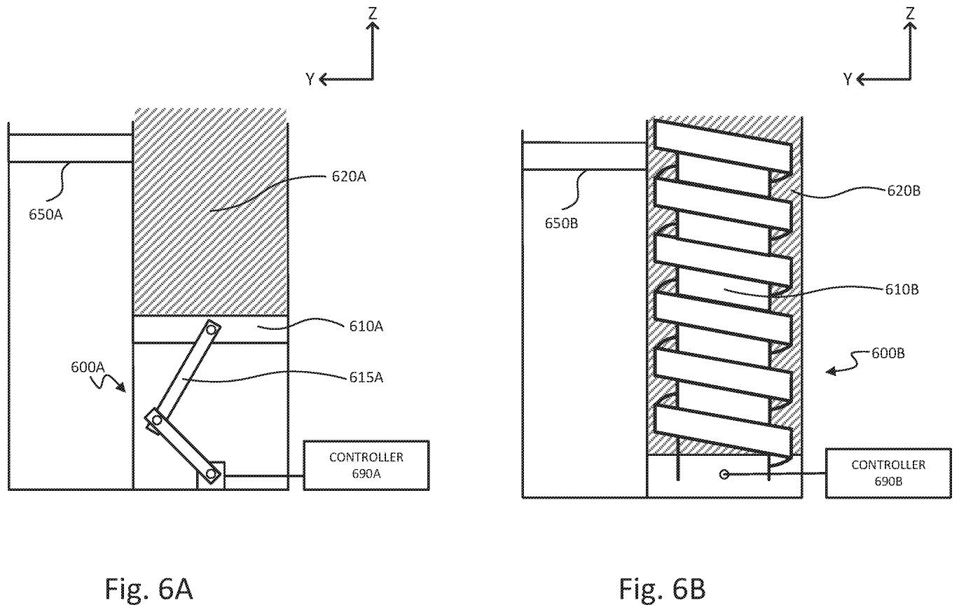

Referring now to the drawings, FIG. 1 is a block diagram illustrating an example of an additive manufacturing system 100 to supply build materials based on theoretical heatmaps. The system 100 is to be coupled to a supply module 110. The supply module 110 may be any mechanism (see, e.g., supply module of FIG. 6A and/or supply module of FIG. 6B) to supply an amount of build material 120 to a build bed 150. In other examples, the system 100 may comprise the supply module 110 therein. The build bed 150 may be internal or removable to the additive manufacturing system 100 (e.g., the build bed may not be present when the printer is shipped). The build bed 150 may be a surface to receive build material in the form of, for example, build material layers having a generally uniform thickness. The generally uniform thickness may range from about 80 microns to about 120 microns, or bigger or smaller. The system 100 further comprises a controller 130 in connection with the supply module 110. The controller connection may be by means of a physical wire and/or wireless. The term “controller” as used herein may include a series of instructions encoded on a machine-readable storage medium and executable by a single processor or a plurality of processors. Additionally, or alternatively, a controller may include one or more hardware devices including electronic circuitry, for example a digital and/or analog application-specific integrated circuit (ASIC), for implementing the functionality described herein.

As used herein, the term “about” is used to provide flexibility to a numerical range endpoint by providing that a given value may be, for example, an additional 15% more or an additional 15% less than the endpoints of the range. The degree of flexibility of this term can be dictated by the particular variable and would be within the knowledge of those skilled in the art to determine based on experience and the associated description herein.

The controller may receive data representing a slice of a model of an object to be generated from a layer of build material. The data to print a 3D object may be derived from a 3D object model of a 3D object. An example of a 3D object model may be generated using a Computer Aided Design (CAD) application which is a tool that may be used to create precision drawings or technical illustrations. Another example of a 3D model may be a Computer Aided Manufacturing (CAM) application which is a tool that may be used to design products such as electronic circuit boards in computers and other devices. The 3D printing data may, for example, describe at which locations on a build bed (e.g., build bed 150) drops of different print agents should be printed. Some examples of printing agents are fusing agents and detailing agents. A 3D object model may be defined in vector type format, and 2D rasterized images may be generated from each representing slices of the object model. Each slice may then be processed to determine how printing agents should be printed to generate a layer of an object corresponding to the slice. The 3D printing data defines the 3D object to print by, for example, defining the plurality of slices of said object model to be generated. Each slice may determine a cross-sectional area and/or a cross-sectional shape of the 3D object to be produced by the additive manufacturing system 100 and determines the print agents that should be printed on each formed layer of build material. The cross-sectional area and/or the cross-sectional shape, may be the areas to be fused. Therefore, a slice from the plurality of slices may define which sections of the build material layer may need to be fused to generate each layer of the 3D object.

In the present disclosure, the detailing agent may be understood as any agent that provides temperature control. In an example, the detailing agent may be applied around the boundaries of areas printed with the fusing agent, or may modulate the effect of the fusing agent. In another example, the detailing agent may be used internally for internal features, and for temperature control of internal areas. If the amount of irradiation and temperature are not properly controlled, too much of the printed areas and surrounding un-solidified build material from the build material layer may melt, or the printed areas may not melt sufficiently. This may lead to overheating of some areas and thermal bleed, therefore causing non-intended portions of the build material to melt. It may also cause thermal run-away, where future layers melt without any fusing agents being printed thereon. For example, when a printed area is selectively melted, smaller areas may tend to cool faster than larger areas, resulting in potentially weaker mechanical properties in the smaller areas. The detailing agent may include, for example, a clear liquid, or a colored liquid. According to one example, a suitable detailing agent may be a formulation commercially known as V1Q61A “HP detailing agent” available from HP Inc.

The controller 130 is to generate a theoretical heatmap 140 representing portions of a layer of build material 120 heated during processing of a previously formed layer supplied to the build bed 150. The theoretical heatmap 140 may be a 2D raster image (e.g., a bitmap) representing the estimated temperature of different discrete spatial locations of a build material layer on the build bed 150 when the fusing operation is happening. In an example, the theoretical heatmap 140 may comprise a plurality of areas of pixel of the 2D raster image wherein each code area shows a temperature range. For example, the theoretical heatmap 140 may comprise (i) a first coded area that may comprise temperatures from about 190° C. to higher temperatures, (ii) a second coded area may comprise temperatures from about 180° C. to about 190° C., (iii) a third coded area may comprise temperatures from about 150° C. to about 180° C., (iv) a fourth coded area may comprise temperatures from about 120° C. to about 150° C., (v) a fifth coded area may comprise temperatures from about 60° C. to about 120° C., and (vi) a sixth coded area may comprise temperatures lower than about 60° C. This is a numerical example of a heatmap areas of pixel and many other combinations of coded area ranges, and/or coded area numbers, can be derived therefrom without departing from the scope of the present disclosure.

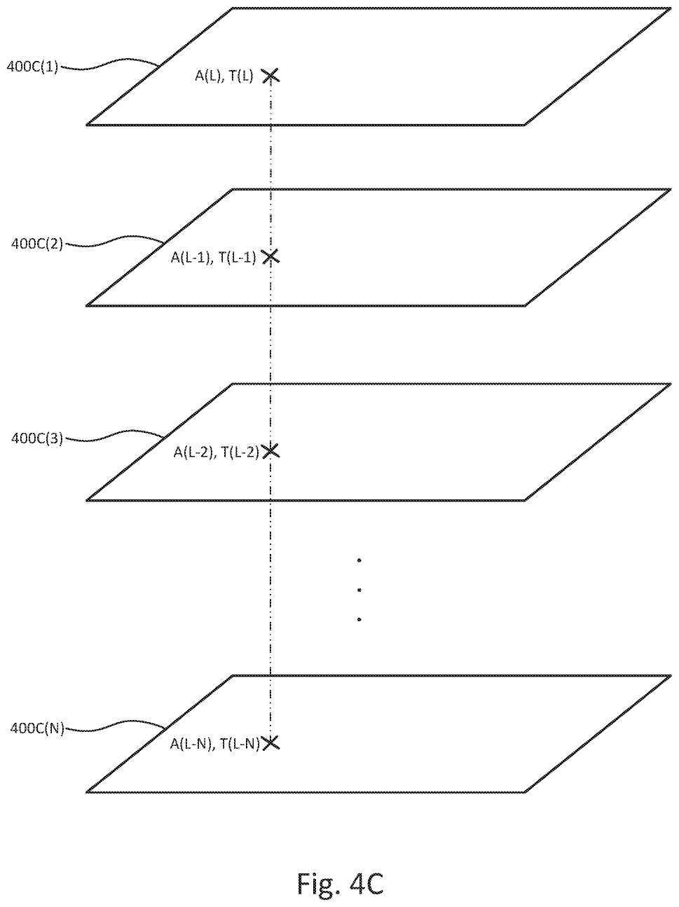

In an example, the controller 130 may generate the theoretical heatmap 140 by calculating the distance from an addressable portion of the slice to a portion of the slice corresponding to the layer that was intended to be fused (see, e.g., examples from FIGS. 4A and 4B). In the same or in a different example, the controller 130 is to calculate the heatmap 140 based on the temperature of an addressable portion of the layer from one or more previously fused layers (see, e.g., example from FIG. 4C). In yet the same or in a different example, the controller 130 is to calculate the theoretical heatmap based on one or more of: characteristics of the build material used; characteristics of a fusing agent used; and/or characteristics of an energy source used. Characteristics may include one or more of: the fusing temperature of the build material; dimensional characteristics of the build material; thickness of the layer of the build material; type of fusing agent; type of build material used (e.g., polymeric build material, metallic build material, ceramic build material). These are examples and other characteristics of the build material and other characteristics of the fusing agent may be used without departing from the scope of the present disclosure.

In yet another example, the system 100 may also comprise a heat sensor, such as a heat camera, to measure an actual temperature distribution of the build bed 150.

The controller 130 is to calculate, based on the theoretical heatmap 140, an amount of build material 120 needed in a next layer to be supplied to the build bed 150. In an example, the controller 130 may calculate the amount of build material 120 needed in a next layer by also taking into consideration the characteristics of the build material and/or the characteristics of the fusing agent used. In an example, the controller 130 may calculate the amount of build material 120 needed by adding up a build bed baseline build material amount and an additional build material amount. The build bed baseline build material amount may be about the amount of build material 120 to cover the build bed 150 surface at a predetermined layer thickness. The build bed baseline build material amount may be calculated, for example, by multiplying together the build bed width, the build bed length, and the thickness of the next layer. The controller 130 may calculate the additional build material amount by calculating the contraction of the portions of the previously fused layer. For example, the controller 130 may calculate the contraction of the portions of the previously fused layer by determining the portions of the build bed that have a temperature that is greater than or equal to the fusing temperature of the build material. The controller 130 may obtain said temperatures from the theoretical heatmap 140. Reference made herein to fusing temperatures may relate to a temperature which is at least the melting temperature of the build material. In other examples the fusing temperature may relate to a sintering temperature which may be below the melting point of the build material.

The controller 130 is to instruct the supply module 110 to supply the amount of build material 120 to the build bed 150. Some examples of supply module 110 may be found in FIG. 6A and FIG. 6B.

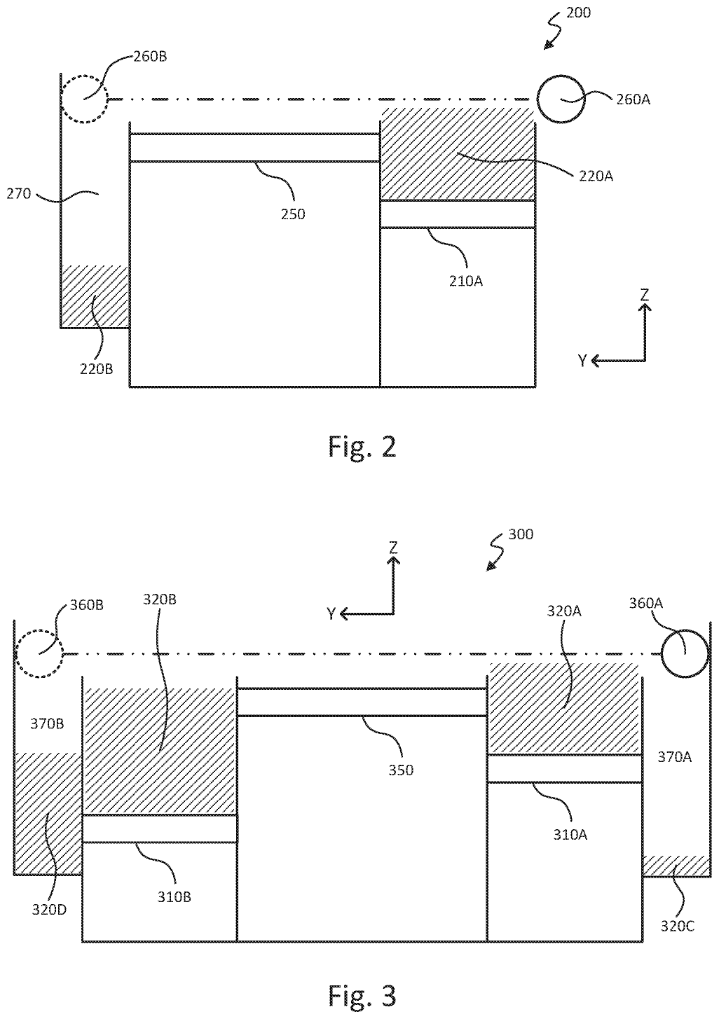

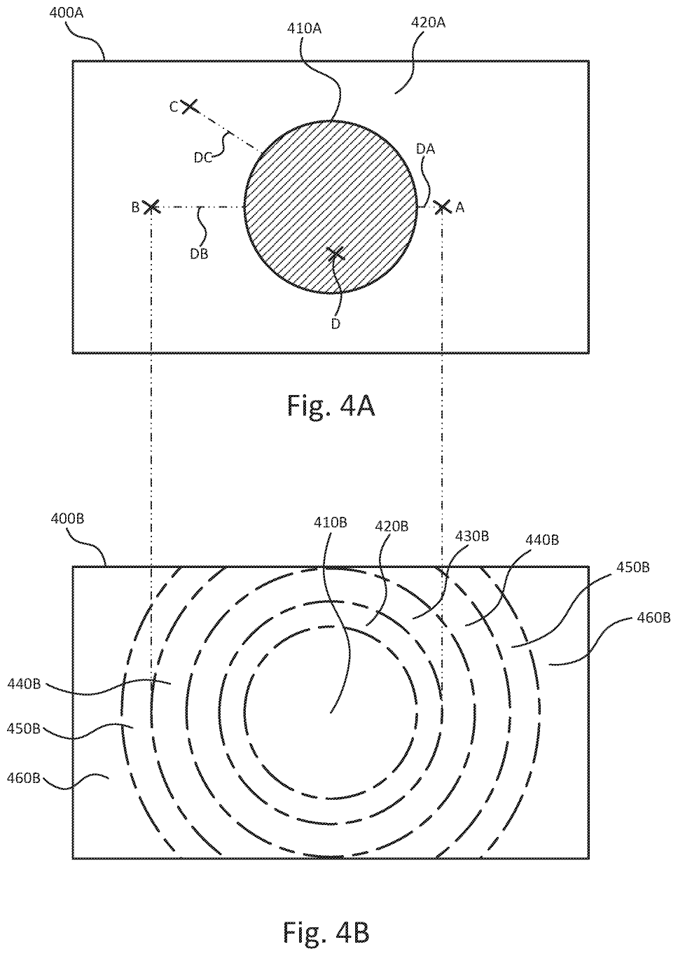

The controller 130 is to instruct a recoating mechanism to spread the amount of build material on the build bed 150 to form a layer. Some examples of a recoating mechanism and the spreading operation may be set forth, for example, in FIG. 2 and FIG. 3.

FIG. 2 is a schematic diagram illustrating an example of an additive manufacturing system 200 to supply build material based on theoretical heatmaps. The system 200 comprises a build bed 250, and a supply module 210A. The build bed 250 may be the same as or similar to the build bed 150 from FIG. 1. The supply module 210A may be the same as or similar to the supply module 110 from FIG. 1. The system 200 may also comprise a controller (not shown) to perform the same functionality as the controller 130 from FIG. 1. The supply module 210A may hold build material 220A and is to supply an amount of said build material 220A to the build bed 250 by, for example, raising its position upwards along the Z axis. This is an example, and other supply modules 210A mechanisms may be used to supply an amount of the build material 220A without departing from the scope of the present disclosure.

The system 200 may also comprise a recoating mechanism 260A to spread the amount of build material 220A on the build bed 250 to form a layer. In an example, the recoating mechanism 260A may be a roller that is to move and spin though the Y axis from a first roller position 260A to a second roller position 260B. In another example, the recoating mechanism 260A may be a roller that spins in the opposite direction to the direction in which the roller is moved. The roller 260A may spread the amount of build material 220A by moving from the first roller position 260A to the second roller position 260B. The system 200 may also comprise an overflow zone 270 to collect the excess build material 220B from the rolling operation. In another example, the recoating mechanism 260A may comprise a rotatory vane that scoops up the certain amount of build material 220A to the roller 260A.

FIG. 3 is a schematic diagram illustrating another example of an additive manufacturing system 300 to supply build materials based on theoretical heatmaps. The system 300 comprises a build bed 350, a first supply module 310A, and a second supply module 310B. The build bed 350 may be the same as or similar to the build bed 150 from FIG. 1. The first supply module 310A, and/or the second supply module 310B may be the same as or similar to the supply module 110 from FIG. 1. In an example, the second supply module 310B may be located at the opposite side of the build bed 350 from the first supply module 310A. The system 300 may also comprise a controller (not shown) to perform the same functionality as the controller 130 from FIG. 1. The first supply module 310A may hold build material 320A and is to supply an amount of said build material 320A to the build bed 350 by, for example, raising its position upwards along the Z axis. The second supply module 310B may hold build material 320B and is to supply an amount of said build material 220B to the build bed 250 by, for example, raising its position upwards along the Z axis. This is an example, and other supply modules 310A and/or 310B mechanisms may be used to supply an amount of the build material 320A and/or 320B without departing from the scope of the present disclosure.

The system 300 may also comprise a recoating mechanism 360A to spread the amount of build material 320A and the amount of build material 320B on the build bed 350 to form build material layers. The system 300 enables the recoating mechanism to spread the amount of build material 320A and 320B bi-directionally. In an example, the recoating mechanism 360A may be a roller that is to move and spin though the Y axis from a first roller position 360A to a second roller position 360B. In another example, the recoating mechanism 360A may be a roller that spins in the opposite direction to the direction in which the roller is moved. The roller 360A may spread the amount of build material 320A by moving from the first roller position 360A to the second roller position 360B. The system 300 may also comprise an overflow zone 370B to collect the excess build material 320D of the rolling operation from the first roller position 360A to the second roller position 360B. In the same example, the recoating mechanism 360A may be a roller that is to roll though the Y axis from a second roller position 360B to a first roller position 360A. The printing roller 360B may spread the amount of build material 320B by rolling from the second roller position 360B to the first roller position 360A. The system 300 may also comprise an overflow zone 370A to collect the excess build material 320C of the rolling operation from the second roller position 360B to the first roller position 360A. In other examples, the recoating mechanism 360A may comprise a rotatory vane that scoops up the certain amount of build material 320A and/or 320B to the roller 360A and/or 360B.

FIG. 4A-4C illustrate examples of how a controller (e.g., controller 130 from FIG. 1) may generate a theoretical heatmap (e.g., theoretical heatmap 140 from FIG. 1).

FIG. 4A is a schematic diagram illustrating an example of a previously fused build material layer 400A. In an example, the previously fused build material layer 400A may be the previously fused build material layer from system 100 from FIG. 1. The build material layer 400A comprises a fused zone 410A and a non-fused zone 420A. In other examples, the build material layer may comprise a plurality of fused zones 410A and/or a plurality of non-fused zones 420A. The non-fused zone 420A comprises a plurality of not-fused portions, for example: (i) illustrated portion A that is located at a DA distance from the closest fused portion; (ii) illustrated portion B that is located at a DB distance from the closest fused portion; and (iii) illustrated portion C that is located at a DC distance from the closest fused portion. The fused zone 410A comprises a plurality of fused portions, for example, (iv) illustrated portion D. For the sake of example, four points from the slice have been described, however in other examples more or less points may be used.

FIG. 4B is a schematic diagram illustrating an example of a theoretical heatmap 400B. The theoretical heatmap 400B may be the same as or similar to the theoretical heatmap 140 from FIG. 1. In an example, the theoretical heatmap 400B may correspond to the theoretical heatmap 400B from the previously fused build material layer 400A from FIG. 4A. The theoretical heatmap 400B may comprise a plurality of areas of pixel indicating a plurality of temperature ranges of the previously fused build material layer during and/or after the fusing operation. In an example, the theoretical heatmap 400B comprises six areas of pixels: (i) a first coded area 410B comprising the portions of the build material layer whose temperatures are equal or higher than about 190° C.; (ii) a second coded area 420B comprising the portions of the build material layer whose temperatures are comprised in the range defined by about 180° C. and about 190° C.; (iii) a third coded area 430B comprising the portions of the build material layer whose temperatures are comprised in the range defined by about 150° C. and about 180° C.; (iv) a fourth coded area 440B comprising the portions of the build material layer whose temperatures are comprised in the range defined by about 120° C. and about 150° C.; (v) a fifth coded area 450B comprising the portions of the build material layer whose temperatures are comprised in the range defined by about 60° C. and about 120° C.; and (vi) a sixth coded area 460B comprising the portions of the build material layer whose temperatures are equal or less than about 60° C. An example of theoretical heatmap 400B areas of pixel elements has been disclosed, however many other examples can be derived therefrom with, for example, a different amount of areas of pixels and different temperature ranges, without departing from the scope of the present disclosure.

In an example, a controller (e.g., controller 130 from FIG. 1) may generate the theoretical heatmap 400B based on the distance from an addressable portion of the layer to a portion of the layer that was intended to be fused. For example, the first coded area 410B may correspond to the fused zone 410A from FIG. 4A, therefore said zone temperatures may be equal or higher than the build material fusing temperature (the illustrated portion D from FIG. 4A temperature representation may be part of the first coded area 410B in the theoretical heatmap 400B). Following with the example, the temperature representation of the portions of the non-fused zone (e.g., non-fused zone 420A from FIG. 4A) may depend on the distance to the closest portion from the fused zone. For example, the temperature representation of portion A may have a higher temperature value than the temperature representation of portion B, since distance DA is smaller than distance DB (see, distances DA and DB in FIG. 4A). In an example, the temperature of each non-fused portion from the theoretical heatmap 400B may be estimated by taking into account the distance to the closest point of fused build material. In another example, the temperature of each non-fused portion from the theoretical heatmap 400B may be estimated by taking into account multiple distances of a respective multiple points of fused build material.

In some additional examples, the controller may assign a temperature to an addressable portion based on a look up table. The look up table may match distances to the fused build material with its respective temperatures. This is an example, and many other implementations may be derived therefrom.

In an additional example, the controller may generate the heatmap 400B by taking into account some characteristics of the build material used, such as the melting temperature of the powder particles. In another additional example, the controller may generate the heatmap 400B by taking into account the characteristics of the fusing agent used that may have an effect in the temperature of the different portions of the build bed, such as the fusing agent absorptivity or the color. In yet another additional example, the controller may generate the heatmap 400B by taking into account the atmospheric conditions surrounding the build bed that may have an effect in the build bed temperature, for example, the temperature and/or the humidity.

In other examples, other variables may be considered when generating the heatmap 400B.

FIG. 4C is a schematic diagram illustrating an example of a plurality of previously fused build material layers 400C(1)-400C(N). A controller (e.g., controller 130 from FIG. 1) may calculate the theoretical heatmap (e.g., theoretical heatmap 400B) based on the temperature of an addressable portion of the layer from one or more previously fused layers. The example comprises a previously fused build material layer 400C(1); the second previously fused build material layer 400C(2), which may be the build material layer fused before the previously fused build material layer 400C(1); the third previously fused build material layer 400C(3), which may be the build layer fused before the second previously fused build material layer 400C(2); up to the Nth previously fused build material layer 400C(N); wherein N is a positive integer. The layer 400C(1) may be the same as or similar to the previously fused build material layer 400A from FIG. 4A. The controller may have generated the theoretical heatmaps from at least one of the previously fused build material layers 400C(2)-400C(N), therefore being able to access to the temperatures of the temperatures of the addressable portions of the previously fused build material layers 400C(2)-400C(N). The controller may have generated said theoretical heatmaps, for example, using the same methodology as shown in FIG. 4A and FIG. 4B. The layer 400C(1) may comprise a plurality of portions, for example illustrated portion A(L). The layer 400C(2) may comprise a plurality of portions, for example illustrated portion A(L-1), the theoretical heatmap representation of which illustrates that said portion A(L-1) has a temperature T(L-1). The layer 400C(3) may comprise a plurality of portions, for example illustrated portion A(L-2), the theoretical heatmap representation of which illustrates that said portion A(L-2) has a temperature T(L-2). Up to the layer 400C(N) that may comprise a plurality of portions, for example illustrated portion A(L-N), the theoretical heatmap representation of which illustrates that said portion A(L-N) has a temperature T(L-N). The controller may consider the thermal bleeding of the previously fused layers 400C(2)-400C(N) when generating the theoretical heatmap of layer 400C(1). For example, when generating the theoretical heatmap, the controller may take into consideration the temperature T(L-1) and the distance from A(L) to A(L-1); the temperature T(L-2) and the distance from A(L) to A(L-2); the temperature T(L-3) and the distance from A(L) to A(L-3); up to the temperature T(L-N) and the distance from A(L) to A(L-N). In additional examples, the controller may take into consideration more portions of the subsequent layers 400C(2)-400C(N) to generate the theoretical heatmap of the layer 400C(1). In yet additional examples, the controller may consider other parameters such as the heat conductivity of the build material, humidity, and the like.

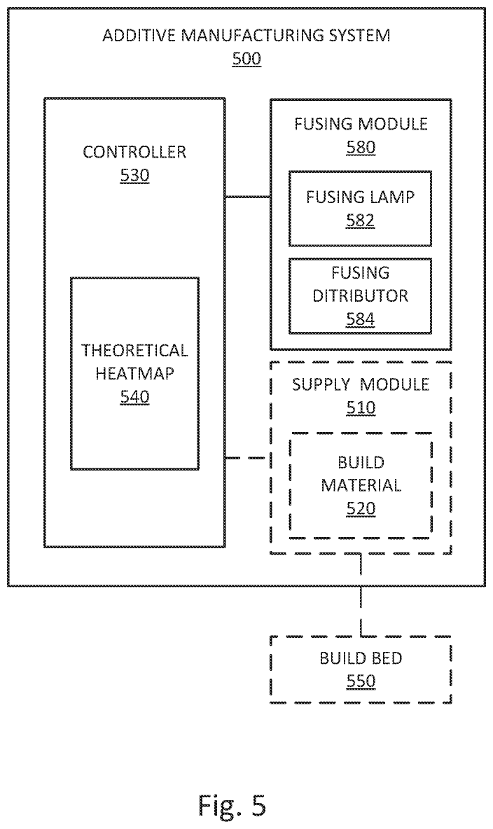

FIG. 5 is a block diagram illustrating another example of an additive manufacturing system 500 to supply build materials based on theoretical heatmaps. The system 500 may be a similar system as the system 100 of FIG. 1. The system 500 is to be coupled to a supply module 510 comprising build material 520. In another example, the system 500 comprises the supply module 510 therein. The supply module 510 and the build material 520 may be the same as or similar to the supply module 510 and the build material 120 from FIG. 1. The system 500 may also comprise a build bed 550 that may be internal or removable to the additive manufacturing system 500 (e.g., the build bed 550 may not be present when the printer is shipped). The build bed 550 may be a surface to receive build material in the form of, for example, build material layers having a generally uniform thickness. The generally uniform thickness may range from about 80 microns to about 120 microns, or bigger or smaller. The system 500 further comprises a controller 530 in connection with the supply module 510. The controller connection may be by means of a physical wire and/or wireless. The term “controller” as used herein may include a series of instructions encoded on a machine-readable storage medium and executable by a single processor or a plurality of processors. Additionally, or alternatively, a controller may include one or more hardware devices including electronic circuitry, for example a digital and/or analog application-specific integrated circuit (ASIC), for implementing the functionality described herein. The controller 530 may be to perform at least the same operations as controller 130 from FIG. 1, for example: (i) to generate a theoretical heatmap 540, representing portions of a layer of build material 520 heated during processing of a previously formed layer supplied to the build bed 550; (ii) to calculate, based on the theoretical heatmap 540, an amount of build material 520 to be supplied to form a next layer on the build bed 550; and (iii) to instruct the supply module 510 to supply the amount of build material 520 to the build bed 550.

System 500 may also comprise a fusing module 580 comprising a fusing agent distributor 584 and a fusing lamp 582. The fusing agent distributor 584 is to selectively eject fusing agent to the build material layer. The fusing lamp 582 is to apply energy to the build material layer. As an example, a fusing lamp 582 may be made of tungsten and may comprise resistive heaters that may irradiate the printing bed 550 with a wide band of energy wavelengths. The fusing agent is a composition that may be applied to the build material layer. In an example, the fusing agent may be a printing liquid composition. When a suitable amount of energy (e.g., energy irradiated by fusing lamp 582) is applied to the combination of build material and fusing agent, said energy may cause the combination of build material and fusing agent to heat up above the melting point and to cause the build material to fuse and solidify. The fusing agent may be stored in a fusing agent repository connected to the fusing agent distributor 584. In an example, the fusing agent repository may be outside the additive manufacturing system 500, however other system examples may include the fusing agent repository therein.

The controller 550 may be coupled to the fusing module 580 and may instruct the fusing distributor 584 to eject fusing agent to the build bed based on, for example, the data representing the next slice of the object model. The controller 550 may further instruct the fusing lamp 582 to apply energy to the build bed 550.

FIG. 6A is a schematic diagram illustrating an example of a supply module 600A. The supply module 600A may be an example of the supply module 110 from FIG. 1. The supply module 600A may hold build material 620A and is to supply an amount of said build material 620A to the build bed 650A. The supply module 600A comprises a supply platform 610A whose height is defined by a raising mechanism 615A to raise (along the Z axis) the height of the supply platform 610A based on the amount of build material 620A to be supplied to form the next layer on the build bed 650A. An example of raising mechanism 615A may be a connecting rod coupled to the supply platform 610A. Another example of raising mechanism 615A may be a telescopic pipe or conduit coupled to the supply platform 610A. Two examples of raising mechanisms have been disclosed, however additional raising mechanism examples may be defined without departing from the scope of the present disclosure. The raising mechanism 615A may be coupled to a controller 690A. The controller 690A may be the same as or similar to the controller 130 from FIG. 1. The controller 690A may be to instruct the raising mechanism 615A to raise the supply platform 600A so that a previously calculated amount of build material 620A is supplied to the build bed 650A.

FIG. 6B is a schematic diagram illustrating another example of a supply module 600B. The supply module 600B may be an example of the supply module 110 from FIG. 1. The supply module 600B may hold build material 620B and is to supply an amount of said build material 620B to the build bed 650B. The supply module 600B comprises an Archimedean screw 610B. An example of an Archimedean screw may be a helical surface surrounding a central cylindrical shaft inside a hollow pipe, so that the helical surface moves up the Z axis of the central cylindrical shaft scooping up the build material 620B from the lower part of the supply module 610B to the top part of the supply module 610B. The Archimedean screw 610B may be coupled to a controller 690B. The controller 690B may be the same as or similar to the controller 130 from FIG. 1. The controller 690B may be to instruct the Archimedean screw 610B to supply the amount of build material 620B needed in the next layer to be supplied to the build bed 650B.

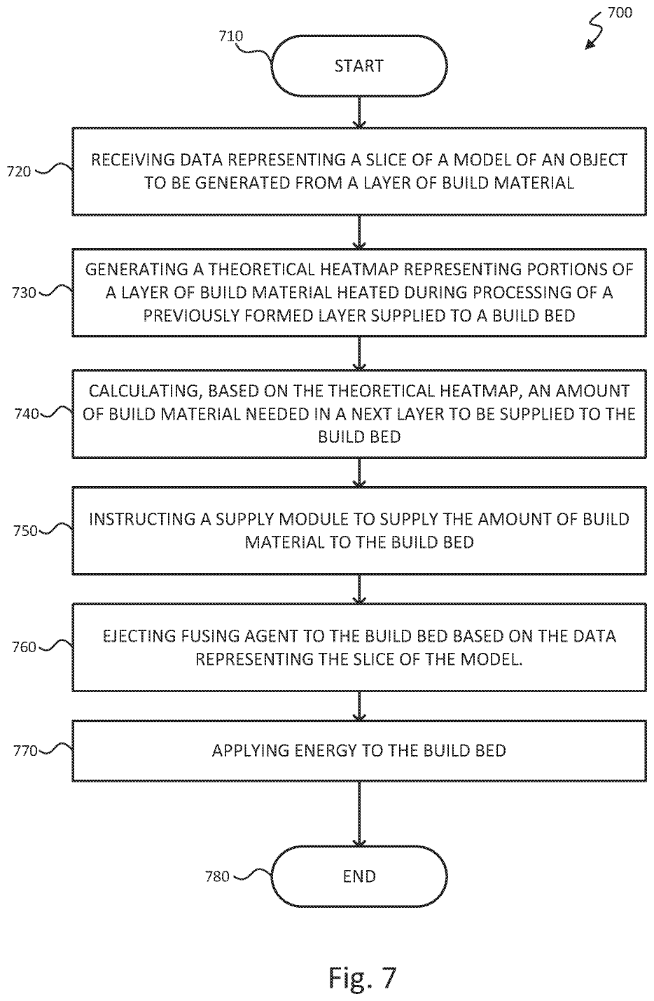

FIG. 7 is a flowchart of an example method 700 for supplying build materials based on a theoretical heatmap. Method 700 may be described below as being executed or performed by a system, such as system 100 of FIG. 1. Various other suitable systems may be used as well, such as, for example system 200 of FIG. 2, system 300 of FIG. 3, and system 500 from FIG. 5. Method 700 may be implemented in the form of executable instructions stored on a machine-readable storage medium and executed by a single processor or a plurality of processors of the apparatus 100, and/or in the form of any electronic circuitry, for example digital and/or analog ASIC. In some implementations of the present disclosure, method 700 may include more or less blocks than are shown in FIG. 7. In some implementations, one or more of the blocks of method 700 may, at certain times, be performed in parallel and/or may repeat.

Method 700 may start at block 710, and continue to block 720, where a controller (e.g., controller 130 from FIG. 1) may receive data representing a slice of a model of an object to be generated from a layer of build material. At block 730, the controller may generate a theoretical heatmap (e.g., theoretical heatmap 140 from FIG. 1) representing portions of a layer of build material heated during processing of a previously formed layer supplied to a build bed (e.g., build bed 150 from FIG. 1). At block 740, the controller may calculate, based on the theoretical heatmap, an amount of build material (e.g., build material 120 from FIG. 1) needed in a next layer to be supplied to the build bed based on at least the estimated corresponding contraction of the build material related to its estimated temperature. At block 750, the controller may instruct a supply module (e.g., supply module 110 from FIG. 1) to supply the amount of build material to the build bed. At block 760, a fusing distributor (e.g., fusing distributor 584 from FIG. 5) may selectively apply fusing agent to the build bed based on the data representing the slice of the model. At block 770, a fusing lamp (e.g., fusing lamp 582 from FIG. 5) may apply energy to the build bed. At block 780, method 700 may end. Method 700 may be repeated multiple times to build the 3D object, each time being printed a subsequent layer.

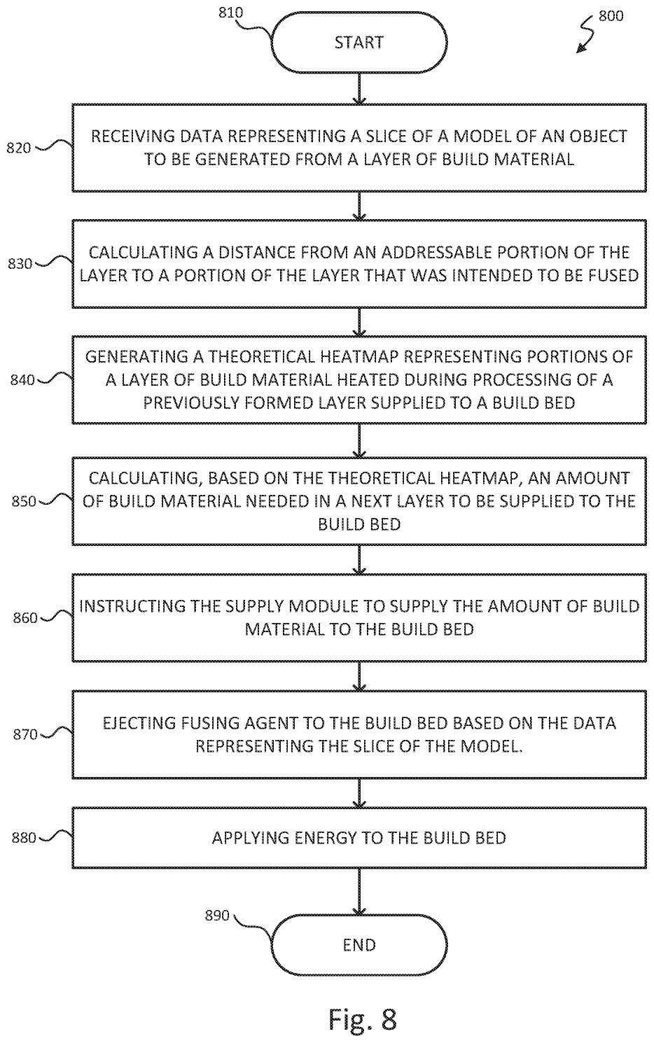

FIG. 8 is a flowchart of another example method 800 for supplying build materials based on a theoretical heatmap. Method 800 may be described below as being executed or performed by a system, such as system 100 of FIG. 1. Various other suitable systems may be used as well, such as, for example system 200 of FIG. 2, system 300 of FIG. 3, and system 500 from FIG. 5. Method 800 may be implemented in the form of executable instructions stored on a machine-readable storage medium and executed by a single processor or a plurality of processors of the apparatus 100, and/or in the form of any electronic circuitry, for example digital and/or analog ASIC. In some implementations of the present disclosure, method 800 may include more or less blocks than are shown in FIG. 8. In some implementations, one or more of the blocks of method 800 may, at certain times, be performed in parallel and/or may repeat.

Method 800 may start at block 810, and continue to block 820, where a controller (e.g., controller 130 from FIG. 1) may receive data representing a slice of a model of an object to be generated from a layer of build material. At block 830, the controller may calculate a distance from an addressable portion of the layer to a portion of the layer that was intended to be fused (e.g., distance DA from FIG. 4A). At block 840 the controller may generate a theoretical heatmap (e.g., theoretical heatmap 140 from FIG. 1) representing portions of a layer of build material heated during processing of a previously formed layer supplied to a build bed (e.g., build bed 150 from FIG. 1). At block 850, the controller may calculate, based on the theoretical heatmap, an amount of build material (e.g., build material 120 from FIG. 1) needed in a next layer to be supplied to the build bed based on at least the estimated corresponding contraction of the build material related to its estimated temperature. At block 860, the controller may instruct a supply module (e.g., supply module 110 from FIG. 1) to supply the amount of build material to the build bed. At block 870, a fusing distributor (e.g., fusing distributor 584 from FIG. 5) may selectively eject fusing agent to the build bed based on the data representing the slice of the model. At block 880, a fusing lamp (e.g., fusing lamp 582 from FIG. 5) may apply energy to the build bed. At block 890, method 800 may end. Method 800 may be repeated multiple times to build the 3D object, each time being printed a subsequent layer.

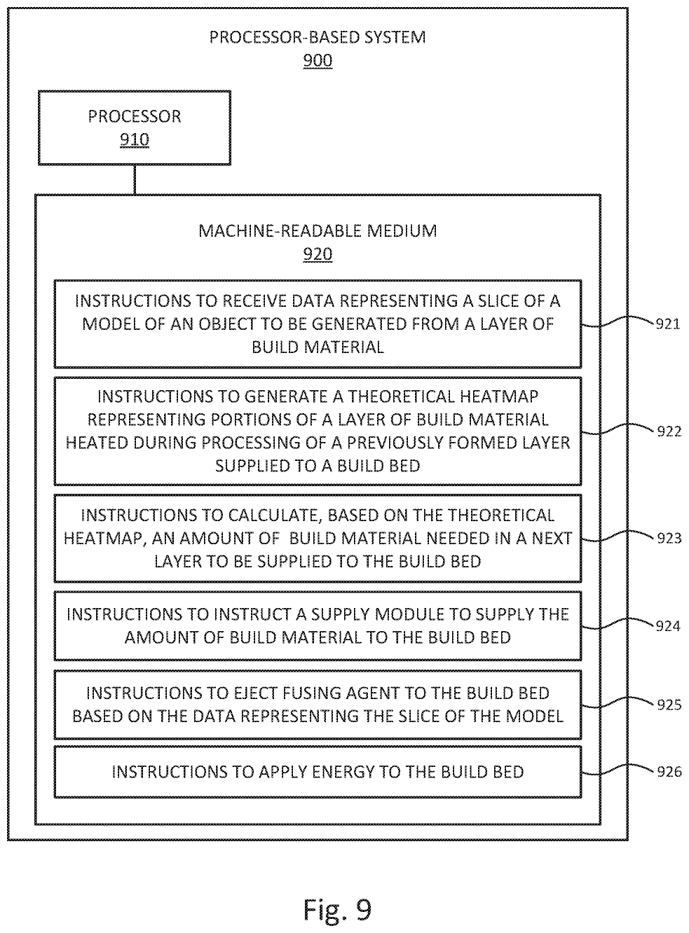

FIG. 9 is a block diagram illustrating an example of a processor-based system 900 to supply build materials based on a theoretical heatmap. In some implementations, the system 900 may be or may form part of a printing device, such as an additive manufacturing system. In some implementations, the system 900 is a processor-based system and may include a processor 910 coupled to a machine-readable medium 920. The processor 910 may include a single-core processor, a multi-core processor, an application-specific integrated circuit (ASIC), a field programmable gate array (FPGA), and/or any other hardware device suitable for retrieval and/or execution of instructions from the machine-readable medium 920 (e.g., instructions 921, 922, 923, 924, 925, and 926) to perform functions related to various examples. Additionally, or alternatively, the processor 910 may include electronic circuitry for performing the functionality described herein, including the functionality of instructions 921, 922, 923, 924, 925, and/or 926. With respect of the executable instructions represented as boxes in FIG. 9, it should be understood that part or all of the executable instructions and/or electronic circuits included within one box may, in alternative implementations, be included in a different box shown in the figures or in a different box not shown.

The machine-readable medium 920 may be any medium suitable for storing executable instructions, such as a random-access memory (RAM), electrically erasable programmable read-only memory (EEPROM), flash memory, hard disk drives, optical disks, and the like. In some example implementations, the machine-readable medium 920 may be a tangible, non-transitory medium, where the term “non-transitory” does not encompass transitory propagating signals. The machine-readable medium 920 may be disposed within the processor-based system 900, as shown in FIG. 9, in which case the executable instructions may be deemed “installed” on the system 900. Alternatively, the machine-readable medium 920 may be a portable (e.g., external) storage medium, for example, that allows system 900 to remotely execute the instructions or download the instructions from the storage medium. In this case, the executable instructions may be part of an “installation package”. As described further herein below, the machine-readable medium may be encoded with a set of executable instructions 921-926.

Instructions 921, when executed by the processor 910, may receive data representing a slice of a model of an object to be generated from a layer of build material. Instructions 922, when executed by the processor 910, may generate a theoretical heatmap (e.g., theoretical heatmap 140 from FIG. 1) representing portions of a layer of build material heated during processing of a previously formed layer supplied to a build bed (e.g., build bed 150 from FIG. 1). Instructions 923, when executed by the processor 910, may cause the processor 910 to calculate, based on the theoretical heatmap, an amount of build material (e.g., build material 120 from FIG. 1) needed in a next layer to be supplied to the build bed. Instructions 924, when executed by the processor 910, may cause the processor 910 to instruct the supply module (e.g., supply module 110 from FIG. 1) to supply the amount of build material to the build bed. Instructions 925, when executed by the processor 910, may cause the processor 910 to eject fusing agent to the build bed. Instructions 926, when executed by the processor 910, may cause the processor 910 to apply energy to the build bed.

The machine-readable medium 920 may include further instructions. For example, instructions that when executed by the processor 910, may cause the processor 910 to generate the theoretical heatmap by calculating a distance from an addressable portion of the layer to a portion of the layer that was intended to be fused.

The above examples may be implemented by hardware, or software in combination with hardware. For example, the various methods, processes and functional modules described herein may be implemented by a physical processor (the term processor is to be implemented broadly to include CPU, processing module, ASIC, logic module, or programmable gate array, etc.). The processes, methods and functional modules may all be performed by a single processor or split between several processors; reference in this disclosure or the claims to a “processor” should thus be interpreted to mean “at least one processor”. The processes, method and functional modules are implemented as machine-readable instructions executable by at least one processor, hardware logic circuitry of the at least one processors, or a combination thereof.

The drawings in the examples of the present disclosure are some examples. It should be noted that some units and functions of the procedure may be combined into one unit or further divided into multiple sub-units. What has been described and illustrated herein is an example of the disclosure along with some of its variations. The terms, descriptions and figures used herein are set forth by way of illustration. Many variations are possible within the scope of the disclosure, which is intended to be defined by the following claims and their equivalents.

Example implementations can be realized according to the following clauses:

Clause 1: An additive manufacturing system comprising:
a controller to:
   calculate a theoretical heatmap representing portions of a layer of build material heated during processing of a previously formed layer supplied to a build bed,
   calculate, based on the theoretical heatmap, an amount of build material needed in a next layer to be supplied to the build bed,
   instruct a supply module to supply the amount of build material to the build bed, and
   instruct a recoating mechanism to spread the amount of build material on the build bed to form a layer.

Clause 2: The system of clause 1, wherein the controller is to receive data representing a slice of a model of an object to be generated from a layer of build material.

Clause 3: The system of any preceding clause comprising the supply module to supply the amount of build material to the build bed.

Clause 4: The system of any preceding clause, comprising an overflow zone to collect excess build material.

Clause 5: The system of any preceding clause, comprising an additional supply module located at the opposite side of the build bed from the supply module to enable the recoating mechanism to spread the amount of build material bi-directionally.

Clause 6: The system of any preceding clause, wherein the controller is to generate the theoretical heatmap based on a distance from an addressable portion of the layer to a portion of the layer that was intended to be fused.

Clause 7: The system of clause 6, wherein the distance is the distance from the addressable portion of the layer to the portion of the layer to the closest portion of the layer that was intended to be fused.

Clause 8: The system of any preceding clause, wherein calculating the heatmap, the controller is to assign a temperature to the addressable portion based on a look up table matching temperatures with distances.

Clause 9: The system of any preceding clause, wherein the controller is to calculate the theoretical heatmap based on a temperature of an addressable portion of the layer from one or more previously fused layers.

Clause 10: The system of any preceding clause, comprising a heat sensor to measure an actual temperature of the build bed, the controller further to calculate the theoretical heatmap based on a measurement from the heat sensor of the actual temperature of the build bed.

Clause 11: The system of any preceding clause, wherein the controller is to calculate the theoretical heatmap based on the characteristics of the build material used and/or the characteristics of a fusing agent used.

Clause 12: The system of any preceding clause, comprising a fusing module comprising: (i) a fusing distributor to eject fusing agent to the build bed based on the data representing the next slice; and (ii) a fusing lamp to apply energy to the build bed.

Clause 13: The system of any preceding clause, wherein the supply module comprises a supply platform whose height is defined by a raising mechanism coupled to the controller, the controller is to instruct the raising mechanism to raise the height of the supply platform based on the amount of build material needed in the next layer to be supplied to the build bed.

Clause 14: The system of any preceding clause, wherein the supply module comprises an Archimedean screw coupled to the controller, the controller to instruct the Archimedean screw to supply the amount of build material needed in the next layer to be supplied to the build bed.

Clause 15: A method comprising:
receiving data representing a slice of a model of an object to be generated from a layer of build material;
generating a theoretical heatmap representing portions of a layer of build material heated during processing of a previously formed layer supplied to the build bed;
calculating, based on the theoretical heatmap, an amount of build material needed in a next layer to be supplied to the build bed;
instructing the supply module to supply the amount of build material to the build bed;
ejecting fusing agent to the build bed based on the data representing the slice of the model; and
applying energy to the build bed.

Clause 16: The method of clause 15, wherein generating the theoretical heatmap comprises calculating a distance from an addressable portion of the layer to a portion of the layer that was intended to be fused.

Clause 17: A non-transitory machine-readable medium storing instructions executable by a processor, the non-transitory machine-readable medium comprising:
instructions to receive data representing a slice of a model of an object to be generated from a layer of build material;
instructions to generate a theoretical heatmap representing portions of a layer of build material heated during processing of a previously formed layer supplied to the build bed;
instructions to calculate, based on the theoretical heatmap, an amount of build material needed in a next layer to be supplied to the build bed;
instructions to instruct the supply module to supply the amount of build material to the build bed;
instructions to eject fusing agent to the build bed based on the data representing the slice of the model; and
instructions to apply energy to the build bed.

Clause 18: The non-transitory machine-readable medium of clause 15, further comprising instructions to calculate a distance from an addressable portion of the layer to a portion of the layer that was intended to be fused.

What it is claimed is:

1. An additive manufacturing system comprising:
a controller to:
calculate a theoretical heatmap representing portions of a layer of build material heated during processing of a previously formed layer supplied to a build bed,
calculate, based on the theoretical heatmap, an amount of build material needed in a next layer to be supplied to the build bed,
instruct a supply module to supply the amount of build material to the build bed, and
instruct a recoating mechanism to spread the amount of build material on the build bed to form a layer.

2. The system of claim 1, wherein the controller is to receive data representing a slice of a model of an object to be generated from a layer of build material.

3. The system of claim 1, comprising the supply module to supply the amount of build material to the build bed.

4. The system of claim 3, comprising an additional supply module located at the opposite side of the build bed from the supply module to enable the recoating mechanism to spread the amount of build material bi-directionally.

5. The system of claim 1, wherein the controller is to generate the theoretical heatmap based on a distance from an addressable portion of the layer to a portion of the layer that was intended to be fused.

6. The system of claim 5, wherein the distance is the distance from the addressable portion of the layer to the portion of the layer to the closest portion of the layer that was intended to be fused.

7. The system of claim 6, wherein calculating the heatmap, the controller is to assign a temperature to the addressable portion based on a look up table matching temperatures with distances.

8. The system of claim 1, wherein the controller is to calculate the heatmap based on an estimated temperature of an addressable portion of the layer from one or more previously fused layers.

9. The system of claim 1, wherein the controller is to calculate the theoretical heatmap based on the characteristics of the build material used and/or the characteristics of a fusing agent used.

10. The system of claim 2, comprising a fusing module comprising:
a fusing distributor to eject fusing agent to the build bed based on the data representing the next slice; and
a fusing lamp to apply energy to the build bed.

11. The system of claim 1, wherein the supply module comprises a supply platform whose height is defined by a raising mechanism coupled to the controller, the controller is to instruct the raising mechanism to raise the height of the supply platform based on the amount of build material needed in the next layer to be supplied to the build bed.

12. The system of claim 1, wherein the supply module comprises an Archimedean screw coupled to the controller, the controller to instruct the Archimedean screw to supply the amount of build material needed in the next layer to be supplied to the build bed.

13. A method comprising:
receiving data representing a slice of a model of an object to be generated from a layer of build material;
generating a theoretical heatmap representing portions of a layer of build material heated during processing of a previously formed layer supplied to the build bed;
calculating, based on the theoretical heatmap, an amount of build material needed in a next layer to be supplied to the build bed;
instructing the supply module to supply the amount of build material to the build bed;
ejecting fusing agent to the build bed based on the data representing the slice of the model; and
applying energy to the build bed.

14. The method of claim 13, wherein generating the theoretical heatmap comprises calculating a distance from an addressable portion of the layer to a portion of the layer that was intended to be fused.

15. A non-transitory machine-readable medium storing instructions executable by a processor, the non-transitory machine-readable medium comprising:
instructions to receive data representing a slice of a model of an object to be generated from a layer of build material;
instructions to generate a theoretical heatmap representing portions of a layer of build material heated during processing of a previously formed layer supplied to the build bed;
instructions to calculate, based on the theoretical heatmap, an amount of build material needed in a next layer to be supplied to the build bed;
instructions to instruct the supply module to supply the amount of build material to the build bed;
instructions to eject fusing agent to the build bed based on the data representing the slice of the model; and
instructions to apply energy to the build bed.
